(19) United States
(12) Patent Application Publication
(10) Pub. No.: US 2007/0259442 A1
(43) Pub. Date: Nov. 8, 2007

(54) Assay device and process for the testing of fluid samples

(75) Inventors: Martin Gould, Mullica Hill, NJ (US); Robert J. Smalley, Woodbury, NJ (US); Robert Bernstine, Chesapeake City, MD (US)

Correspondence Address: Edmund M. Jaskiewicz, Suite 400, 1730 M Street NW, Washington, DC, 20036, US

(73) Assignee: American Bio Medica Corporation

(21) Appl. No.: 11/827,434

(22) Filed: Jul. 12, 2007

Related U.S. Application Data
(63) Continuation-in-part of application No. 11/007,251, filed on Dec. 9, 2004.

(51) Int. Cl. G01N 21/00; G01N 21/01

(52) U.S. Cl. 436/165; 422/58

(57) ABSTRACT

An assay device for testing of liquid samples for drugs of abuse has a transparent cylindrical container for retaining a liquid sample and a portion of the cylindrical wall is flat. A test strip holder is within the container and is flat so that its front surface corresponds to the flat portion of the container wall. Immunoassay test strips are in pockets on the front face of the strip holder and are visible through the container wall. Each test strip is enclosed in a transparent pocket which has a bottom opening through which the bottom portion of the test strip protrudes to contact the liquid sample within the container. The liquid then wicks upwardly through the test strip to react with reagents within the test strip.

### FIELD OF THE INVENTION

The present invention relates to assay devices for the testing of liquid samples for determining the presence of undesirable chemical constituents, more particularly, to a test device having a container for retaining a liquid sample and test strips within the container for indicating visually the presence of particular drugs of abuse.

### BACKGROUND ART

The increased availability and use of drugs of abuse by the general population has caused employers, governmental agencies, sports groups and other organizations to utilize drug screening both as a condition of employment and in order to maintain safety in the workplace. Typical drug screening tests are performed for the purpose of quickly identifying on a qualitative basis the presence of drugs in a body fluid which may be urine. A complete analysis of the sample might then be carried out in a laboratory in the event that the preliminary screening results are positive. More and more such drug screenings are taking place on site or the workplace and are generally carried out by testing personnel who may have only limited technical training. It is thus important that the drug screening procedure is simple to perform but yield reliable results. Further, the test device must be such so as to enable the testing personnel to avoid any contact with the fluid specimen which is being tested.

Various forms of devices which have been proposed for the collection and taking of body fluids, such as urine, have proved to be cumbersome in operation since they involve a number of separate steps. Initially, the sample was collected and several additional steps were then required to transfer the urine sample to an analysis device. This multiple step procedure required the manual handling of the specimen through various devices and the use of such transfer devices inevitably caused spills which may result in contamination to the tester and surroundings. In addition, non technical personnel who perform the screening tests on urine samples objected to coming into any kind of contact with the urine sample and even the handling of the sample itself.

Another form of a testing device required the transfer of the specimen or at least a portion thereof, to another compartment of the collection container in order to perform the test This transfer of the specimen required vigorous shaking of the container or turning the container upside down in order to cause the flow of the specimen into a test compartment. It was therefore necessary to make the containers leak proof under such conditions and the result was a complicated and expensive container structure.

The testing device also included a screen test card for drugs of abuse which comprised a thin flat member having a plurality of immunoassay test strips fastened side by side in parallel on at least one side of the test card. Each test strip is reactive to provide a visual indication in response to a particular drug of abuse.

The test card was insertable into a cup-like container so as to have one end immersed in a urine sample retained in the container to a pre-determined depth whereby the visual results of each test strip could be seen through a transparent wall of the container or above the container without removing the test card from the container. The test card thus provides for the simultaneous detection of multiple analytes. If the sample should test “positive” to indicate the presence of a drug in the urine, it is necessary to send the sample to a certified laboratory for confirmatory testing.

Other forms of prior art assay devices are disclosed in U.S. Pat. Nos. 6,379,620, 6,497,843 and 6,548,019. These assay devices include a container for a liquid sample and an assay assembly within the container. The assay assembly has test or assay strips mounted on a backing member to contact a wicking material which contacts the liquid sample and serves as a path for the liquid sample to react with chemical agents on the strips to give positive, negative or inclusive results.

However, such assay devices require a precise relationship between the several components of the assay assembly in order that the assay device functions in the manner intended. This necessary relationship was difficult to obtain during the manufacture of the components of the assay assembly and their subsequent assembly within the container.

### BRIEF SUMMARY OF THE INVENTION

It is therefore the principal object of the present invention to provide a novel and improved assay device and process for testing of liquid samples for drugs of abuse.

It is another object of the present invention to provide such an assay device having a novel and improved arrangement of the assay or test elements within a container for retaining a liquid sample.

It is an additional object of the present invention to provide a simple and effective assembly of test elements within a container for retaining a liquid sample.

It is a further object of the present invention to provide such an assay device which facilitates the drug screening procedure.

It is still another object of the present invention to provide a novel and improved structure and process for positioning and locking one or more test strips within a container retaining a liquid sample for testing for drugs of abuse.

The objects of the present invention are achieved and the disadvantages of the prior art are eliminated by the assay test device according to the present invention which may comprise a transparent container for retaining a liquid sample to be tested and one or more immunoassay test strip mounted vertically on the front surface of a liquid impermeable backing member within the container such that the strips are visible through the wall of the container. The top and side edges of each test strip are enclosed and sealed by a retaining or cover member so as to expose a bottom portion of each test strip to contact the liquid sample which flows upwardly into the test strip to react with chemical agents within this strip to indicate the presence or absence of particular drugs of abuse. The cover member is preferably transparent so that the test results on the test strips are viewable.

The container is preferably a cup-like member having a cylindrical side wall which may be tapering and an open top end which is closed by a detachable cover or cap. The backing member is flexible and when assembled within conforms to the inner curvature of the cylindrical wall. The backing member may extend around a major portion of the periphery of the container and has a height substantially equal to the inner height of the container.

The cover member may comprise a single flexible sheet-like element having a plurality of pockets formed therein to accommodate the test strips and is attached to the front surface of the backing member.

The process for testing of liquid samples for drugs of abuse according to the present invention, comprises introducing a liquid sample into a transparent container having an assay assembly therein for chemically analyzing a urine sample. The assay assembly has a backing member and one or more immunoassay test strips are disposed axially on the front surface of the backing member so as to be visible through the container wall. Each of the test strips is enclosed and sealed along its sides and top edge by a transparent cover such that a bottom portion of each test strip is exposed to contact the liquid sample within the container. The liquid sample is then allowed to wick up the test strips by capillary action. The test results are then read on each test strip through the wall of the transparent container.

In a modification, the cylindrical container of the assay test device has a flattened wall portion and a rigid test strip holder made of a clear plastic is locked in position against the inner face of the flattened wall portion. The strip holder has one or more parallel elongated vertically extending pockets and each pocket has an open bottom end. Each pocket has therein an assay test strip and the bottom sample receiving end of the test strip protrudes outwardly of the pocket to contact a liquid sample in the container. Each test strip is visible through the pocket and the container wall so that the test results on each test strip can be read through the container wall. A flange at the top end of the strip holder has an opening which receives a tab at the upper end of the flattened wall portion to position the strip holder against the inner face of the flattened wall portion of the container. The strip holder is locked in this position by hooks which extend upwardly from the container bottom and engage notches on the bottom end of the strip holder.

The process for testing of a liquid sample for the presence or absence of drugs of abuse according to the modification of the present invention comprises retaining a liquid sample, such as urine, in the transparent container which has therein a transparent test strip holder having parallel elongated vertically extending pockets each having an open bottom end. The strip holder is locked into a vertical position such that the pockets are closely adjacent to the flattened wall portion of the container. Each pocket may have therein an immunoassay test strip which has its sample receiving bottom end protruding from the pocket open bottom end. The liquid sample contacts the sample receiving end of the test strip to enable the liquid sample to wick up the test strip by capillary action to react with the test strip. The test results on each strip are then read through the transparent wall of the container.

The strip holder is locked in the vertical or operative position within the container by a tamper-proof lock which prevents removal of the strip holder and its test strips. Any attempts to remove the strip holder would result in damage to the test cup container, such as breaking of the hooks on the container bottom.

### BRIEF DESCRIPTION OF THE SEVERAL VIEWS OF THE DRAWINGS

Other objects and advantages of the present invention will be apparent upon reference to the accompanying description when taken in conjunction with the following drawings, which are exemplary, wherein

FIG. 1 is a perspective of the assay device according to the present invention generally showing the container closed by a cover, and the test strips mounted in the container;

FIG. 2 is a perspective view of the assay device similar to that of FIG. 1 but showing the container cover removed and the assay assembly partially withdrawn from the container;

FIG. 3 is a plan view of the assay assembly in a flattened position;

FIG. 4 is an elevational view of the assay assembly shown in FIG. 3 from an end thereof;

FIG. 5 is a sectional view taken along the line V-V of FIG. 2.

FIG. 6 is a perspective view of the modification of the assay device according to the present invention generally showing the container closed by a cover and the test strip holder locked in position in the container;

FIG. 7 is a perspective view of the assay device similar that of FIG. 6 but showing the container cover removed and the test strip holder partially inserted in the container;

FIG. 8 is a sectional view taken along the line VIII-VIII of FIG. 6 but with the cover removed;

FIG. 9 is a perspective view similar to that of FIG. 7 and looking into the container to show two test strip holders in position in a further modification wherein the container has opposed flattened wall portions;

FIG. 10 is perspective view within a half portion of a container showing the rear side of a test strip holder locked in position;

FIG. 11 is an overall perspective view of a test strip holder looking at the front side thereof;

FIG. 12 is a perspective view into the top of a container to show the locking hooks on the container bottom

FIG. 13 is an overall perspective view of a test strip holder looking at the rear side thereof

### DETAILED DESCRIPTION OF THE INVENTION

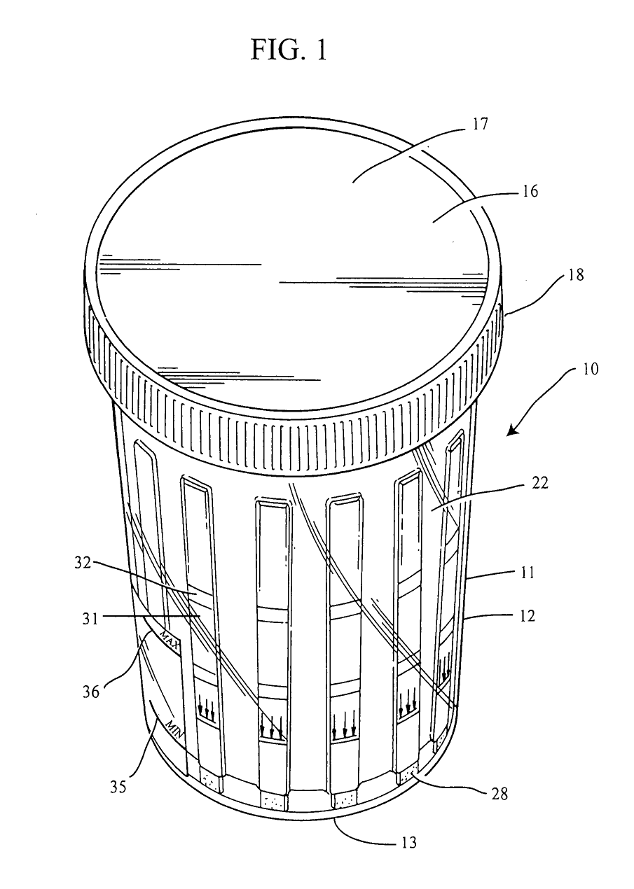

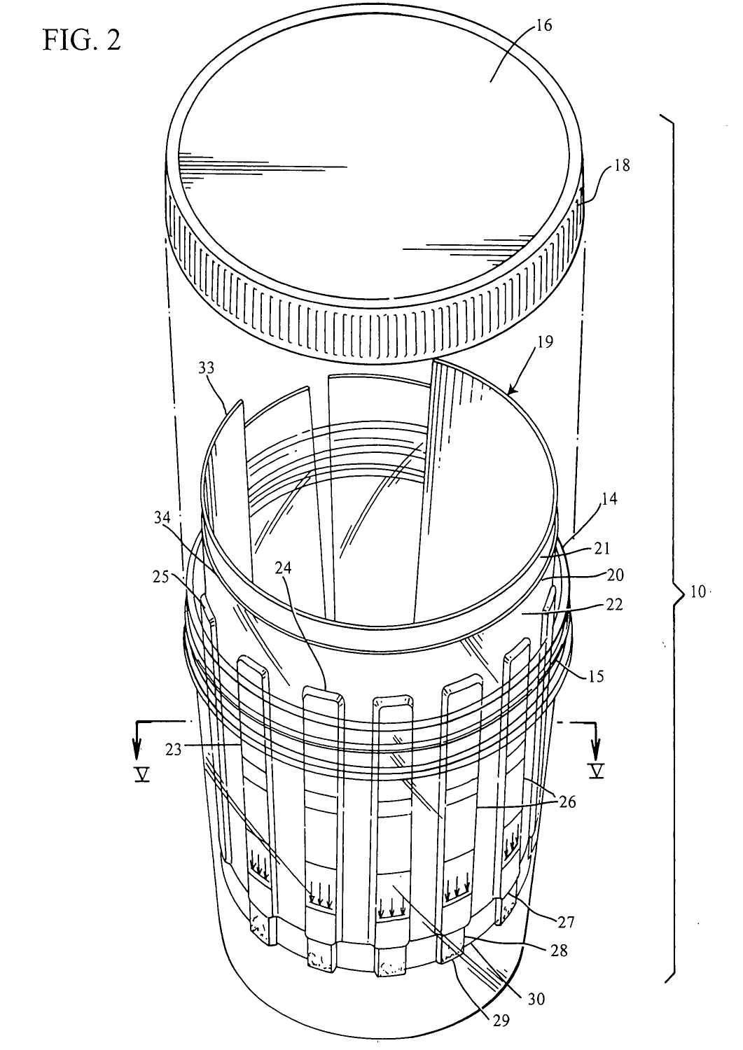

As may be seen in FIGS. 1 and 2, an assay device is indicated generally at 10 and comprises a cup-like transparent test container 11 having a cylindrical side wall 12, a closed bottom 13 and an open top 14. The cylindrical wall 12 may have a slight taper or be straight.

The open end 14 of the test cup 11 is provided with external threads 15 upon which is seated an outer closure cover or cap 16 provided with corresponding internal threads which are not shown in the drawing. The cover 16 has a circular top surface 17 from the periphery of which depends a cylindrical wall 18 on the inner surface of which there are provided the internal threads.

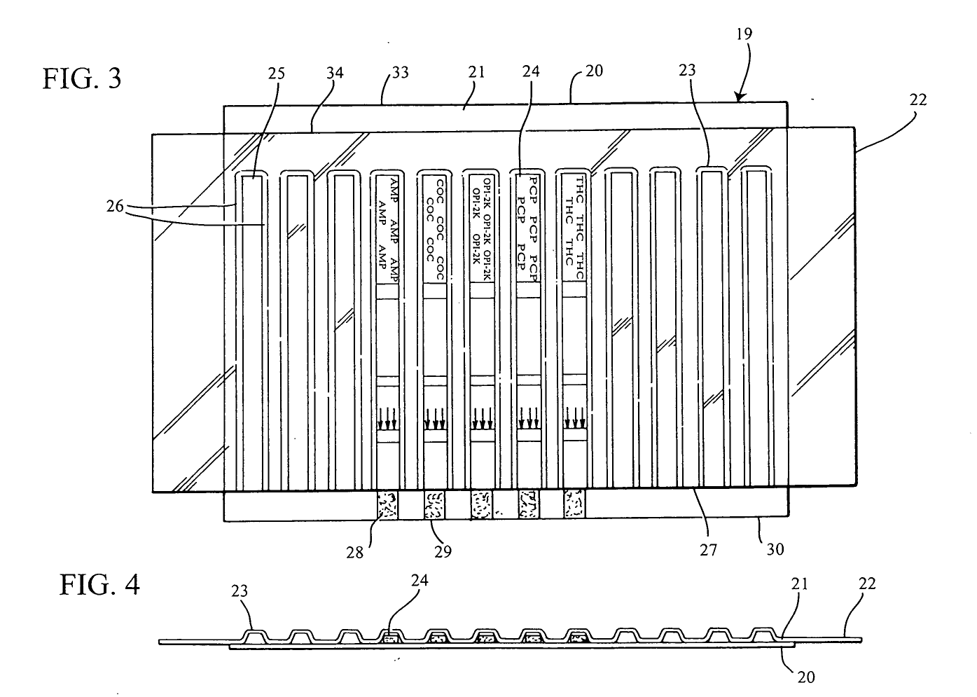

Positioned within the container 11 is an assay assembly indicated at 19 which is partially shown in FIG. 2 and is completely shown in a flattened position in FIG. 3. The assay assembly comprises a flexible backing member 20 of a plastic material which is preferably liquid impermeable and not reactive with any of the components of fluids which might be tested for drugs of abuse. The backing member 20 may be of an opaque plastic material, for example, white in color, or a transparent plastic material.

The backing member has a front surface 21 upon which is attached a substantially rigid but flexible transparent cover sheet 22 which has molded therein a plurality of parallel elongated pockets 23 each of which is shaped to retain closely therein an immunoassay test strip 24. The pockets 23 are positioned such that they extend longitudinally or vertically within the container when the assay assembly is mounted within the container as seen in FIG. 1. Each pocket 23 has its top 25 and longitudinal sides 26 closed or sealed against the body portion of the cover sheet, but the bottom ends 27 of the pockets are open. The test strips 24 each have bottom portions 28 which extend outwardly of the pockets through these open bottom ends 27 and extreme ends 29 of the bottom portions 28 coincide with a bottom edge 30 of the backing member 20. The test strips 24 are thus retained in their vertical positions which are axially of the container by being closely enclosed within the pockets 23.

The bottom portion 28 of each test strip functions as a sample receiving area. Each test strip also has a test area 31 and a control area 32.

The test strips 24 may be attached or adhered directly to the front surface 21 of the backing member 20 such that retaining pockets 23 or similar retaining structures are no longer necessary.

The height of the backing member 20 is substantially equal to the inner height of the container such that, when assembled within the container, the bottom edge 30 of the backing member rests on the bottom of the container and a top edge 33 of the backing member is flush with the top edge 14 of the container. Top edge 34 of the cover sheet is spaced downwardly from the top edge 33 of the backing member as may be seen in FIG. 3.

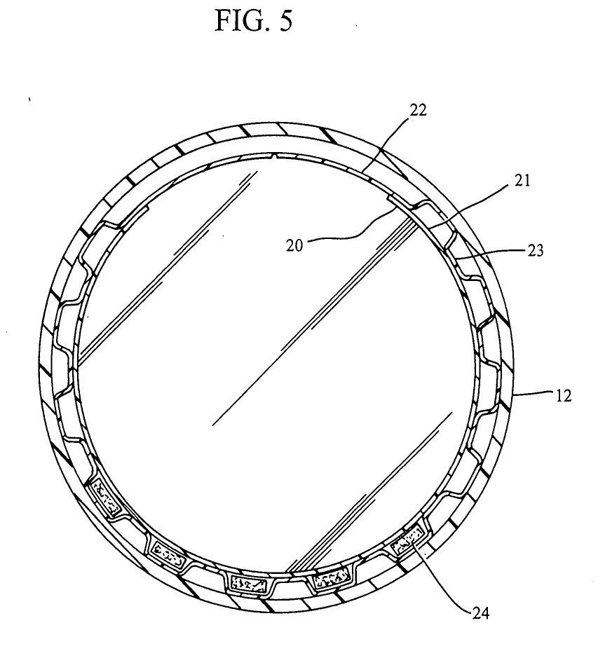

The cover sheet member 22 has a length, when flattened as shown in FIG. 3, which is substantially equal to the inner periphery of the container such that its ends 22A and 22B meet in abutting relation as shown in FIG. 5. However, the length of the cover sheet member may be increased such that the ends 22A and 22B will overlap. These overlapping ends may be provided with a registering depression and protuberance such that they can be snapped together to maintain the cover sheet member in a cylindrical shape which fits closely within the container. Other forms of snaps or clips can be provided to lock abutting or overlapping ends into position.

These particular test strips 24 indicate the presence or absence of the following specific drugs of abuse: PCP, cocaine, amphetamines (AMP), marijuana (THC) and opiates. Test strips 24 may be of the type as made by Phamatech of San Diego, Calif. and Arista Biological of Bethlehem, Pa. Such test strips are characterized as immunoassay strips and employ colloidal gold chemistry.

In addition to immunoassay test strips 24 in the pockets 23, a test strip similar in size and shape to the test strips 24 but having adulterant detection means may be placed in a pocket 23. Such an adulterant strip is capable of determining whether a sample of urine has been tampered with by administering either chemical analysis to ensure that the chemical composition of the sample is consistent with that of standard, non adulterated human urine and/or temperature analysis to ensure that the sample has been recently excreted from the donor and has not been brought to the test site by the donor from an earlier excretion. Such adulterant strips are known in the art.

Each of the test strips 24 is a one-step immunoassay in which a specially treated drug, (drug conjugate) competes with a drug which may be present in the sample specimen for the limited number of binding sites on an antibody. The test strip consists of a membrane strip onto which a drug conjugate has been immobilized. A Colloidal gold-antibody complex is dried at one end of the membrane. In the absence of any drug in the urine sample, the colloidal gold-antibody complex moves with the urine sample by capillary action to contact the immobilized drug conjugate. An antibody-antigen reaction occurs forming a visible line in the test area 31 of the test strip. The formation of a visible line occurs when the test is negative for the drug. When a drug is present in the urine sample, the drug or its metabolite will compete with the immobilized drug congate in the test area for the limited antibody sites on the colloidal gold-labeled antibody complex. If a sufficient amount of drug is present, it will fail all of the available binding sites, thus preventing attachment of the label antibody to the drug congate. An absence of a color line or band in the test area is indicative of a positive result. A control zone 32 or line comprised of a different antibody/antigen reaction is present on the membrane strip. The control line is not influenced by the presence or absence of drug in the urine and therefore should be present in all reactions.

In summary, if a single band appears in the control zone 32, then the results are “positive” which indicates that that particular drug is present above a predetermined level which is usually around 50 ng/ml. If two color bands appear, one in the control region and the other in the test region, then the rest of the results are “negative” which indicates that the level of that particular drug is below the predetermined detection of sensitivity.

In the event there are no distinct color bands visible in both the test zone and the control zone or if there is a visible band in the test zone but not in the control zone, then the result is invalid and testing of the specimen is recommended with another test card.

The quantity of liquid sample should be below a “maximum” line 36 which is shown on the container. If the quantity of the sample is above “maximum”, the test will not be affected since only a sufficient amount of liquid to conduct the test will flow into the open bottom end of a pocket. This quantity of liquid is limited by the air pressure built up in the closed pocket. The liquid sample contacting the bottom end of each test strip will wick up the test strip by capillary action to reach the chemical agents contained within the test strip to give positive, negative or inconclusive test results. These results will be visible in the test area 31 of the strip and can also be seen through the transparent wall of the container.

Any excess sample liquid may enter the open end of a pocket but only to a limited degree as described above. However, this entering would be after the wicking of the sample has already begun when the sample contacted the bottom portions of the test strips resting on the bottom of the container. Thus, this assay device enables one to obtain rapidly a visual, qualitative result which is very advantageous for forensic purposes but is not limited to such purposes.

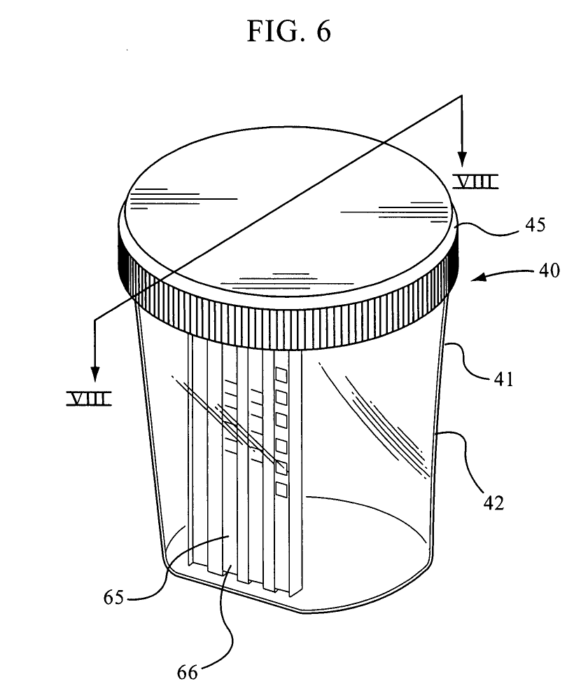

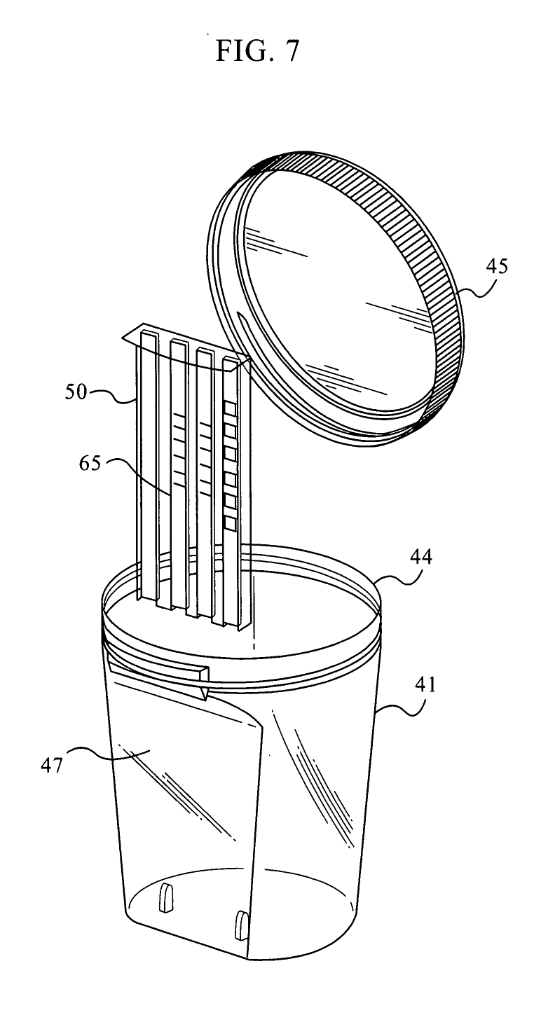

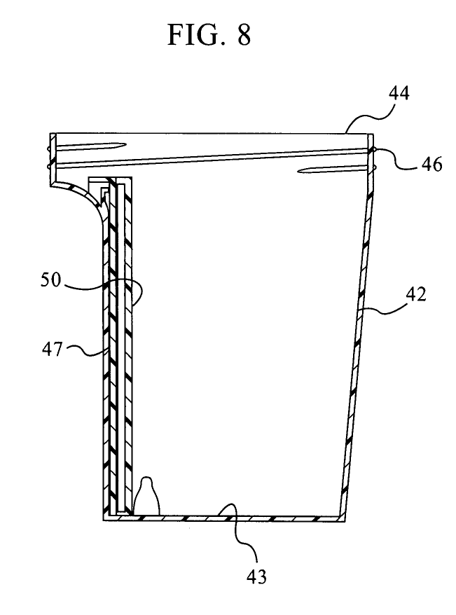

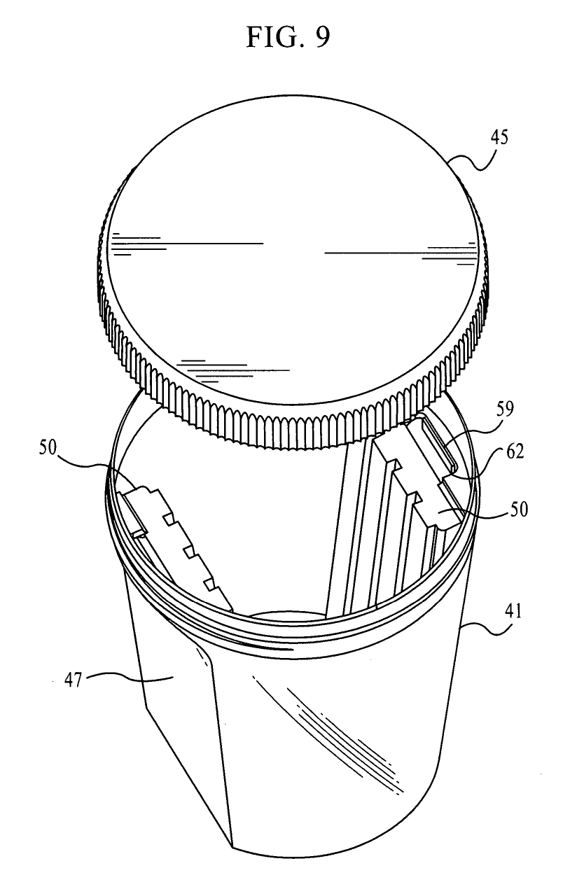

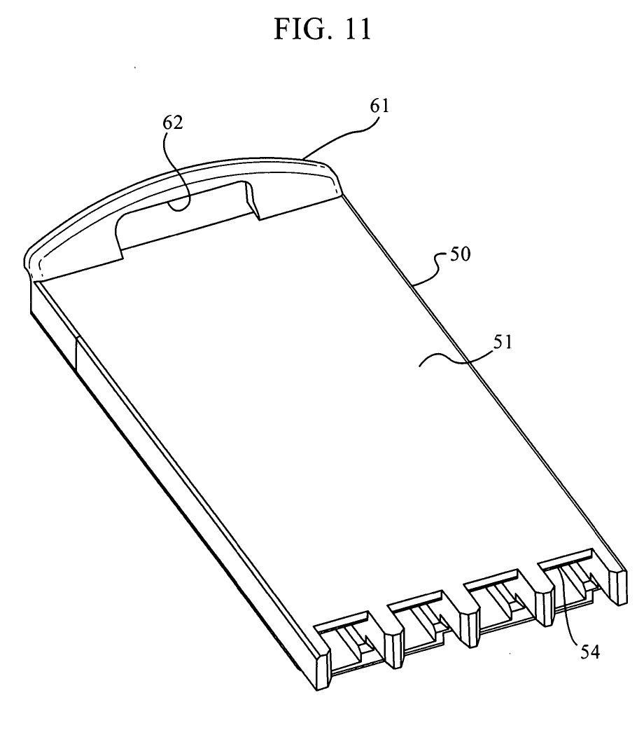

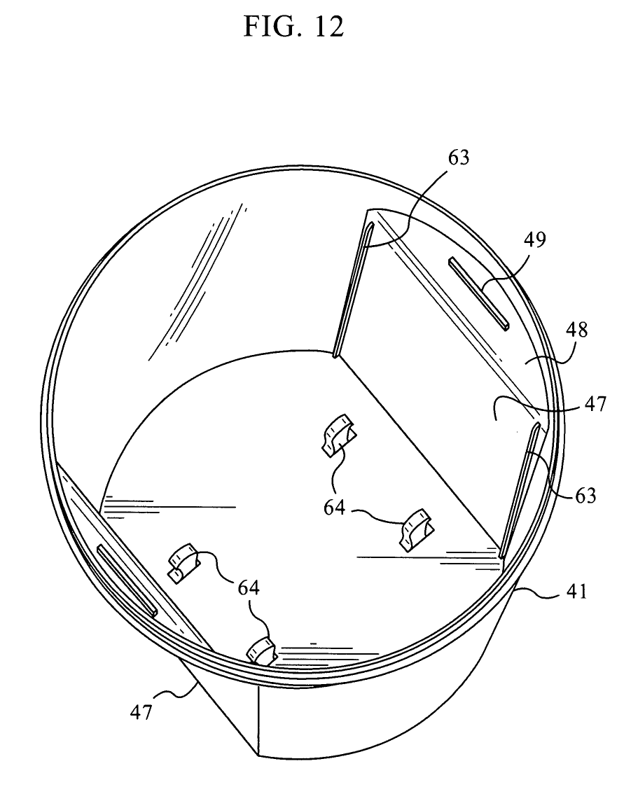

A modification of the present invention is shown in FIGS. 6-12. In FIG. 6 may be seen an assay device indicated generally at 40 and comprising a cylindrical cup-like transparent container 41 for retaining the liquid sample to be tested and formed from a clear, transparent plastic. The container has a side wall 42, which may have a slight taper, a closed bottom 43 and an open top 44 which is closed by a threaded cap or cover 45 similar to the cap 16 described above, and is similarly seated on external threads 46 at the top end of the side wall 42.

A portion of the container side wall 42 below the external threads thereon is flattened at 47 to form a shoulder 48 within the container and a tab 49 projects upwardly on the shoulder 48.

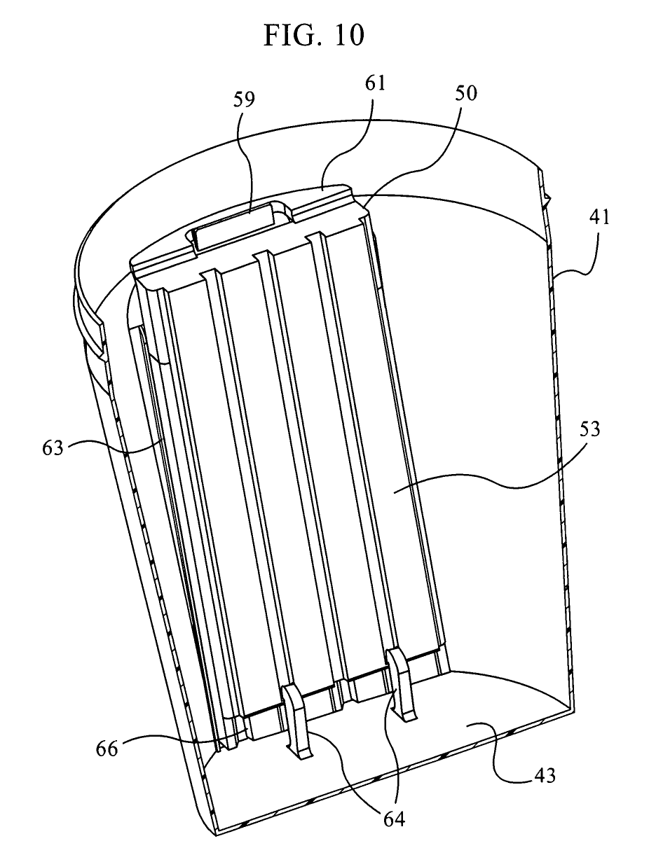

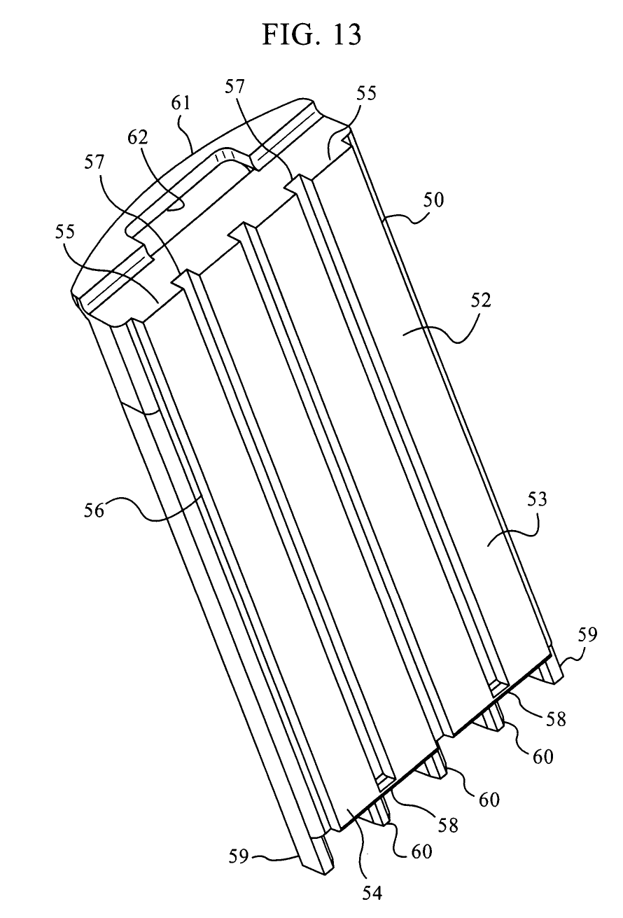

The container may also be provided with two (2) flat portions 47, opposed from each other as may be seen in FIGS. 9 and 12.

Within the container 41 is a rigid, inflexible test strip holder 50 which is liquid impermeable and formed from a clear, transparent plastic by injection molding. The strip holder 50 is flat and is rectangular in shape with its longer dimension being positioned vertically within the container as seen in FIG. 10. The strip holder 50 has a flat front surface 51 and a rear surface 52 upon which are formed a plurality of parallel elongated vertically extending pockets 53. The bottom ends of the pockets are open at 54 but each pocket is closed at its top end 55 and along its vertical sides 56. Narrow grooves 57 are formed between the pockets 53 and extend the length of the strip holder. Two of the grooves 57 are closed at their bottom ends to form a ledge or catch 58 as seen in FIG. 13. The strip holder has vertical sides 59 and between the pockets 53 are partitions 60 which extend below the bottom openings of the pockets to provide a base or support for the strip holder upon the bottom 43 of the container.

At the upper end of the strip holder, a flange 61 extends at substantially a right angle in a direction away from the front face 51 of the strip holder and is provided with a slotted opening 62.

On the interior surface of the flat wall portion 47 there are a pair of spaced vertically extending parallel ridges 63 between which the strip holder is positioned to restrain the strip holder against lateral movement.

On the container bottom 43 spaced from the flattened wall portion 47 are two hooks 64 which are so spaced and shaped to snap over the ledges 58 on the rear face of the strip holder when the strip holder has been inserted into the container into position on the bottom of the container. In this position of the strip holder, the tab 49 on the interior shoulder 48 in the container is received in the slot 62 in the strip holder flange 61. The strip holder 50 is thus securely locked in this inserted or operative position. The engaging of the strip holder flange 61 with the tab 49 and the engaging of the container hooks 64 with the ledges 58 on the rear face of the strip holder provide a tamper-proof lock of the strip holder within the container cup. This locking prevents removal of the strip-holder unless the hooks or the plastic container are broken.

An immunoassay test strip 65 of the type as described above is inserted in one or more of the strip holder pockets 53. One end 66 of the test strip is the beginning or sample receiving end and protrudes outwardly of the open bottom end 54 of the pocket and may contact bottom 43 of the container 41. End 66 is thus exposed to and is in contact with a liquid sample in the container.

The test strip is known in the art and is of the lateral flow type which has a semi-rigid backing of usually a plastic, such as mylar, upon which is mounted a strip of porous material, such as cellulose, which is capable of transporting a solution by capillary action, i.e. wicking. Different areas or zones in the strip contain reagents needed to produce a detectable visual signal as the analyte is transported to or through said zones as described above. The test strips may be of the single or multi-test type or may have adulterant detection means as described above.

The strip holder pockets 53 are so shaped that the test strips fit closely therein so that the sample liquid will flow only by wicking up the test strip and will not flow upwardly around the test strip.

The pockets also may taper slightly inwardly toward the top of the strip holder to, in effect, squeeze the longitudinal sides of the test strip so as to secure the test strip in its pocket.

When the strip holder 50 is locked in its operative position in the container 41, the flat front face 51 of the strip holder will lie against the inner surface of the flat wall portion 47 of the container. This position enables the results on the test strips in the strip holder to be readily seen through the strip holder front face 51 and container flat wall portion 47.

This flat wall portion also enables the test results on the test strips to be easily and accurately read by electronic reader or scanner as known in the art.

As another modification, the strip holder may be made with a curvature so that its front surface would conform closely to the inner configuration of a cylindrical container when placed in the operative position in the container.

Thus, it can be seen that the present invention discloses a novel and improved assay device for testing of liquid samples for drugs of abuse. This assay device could be modified to test for other substances by utilizing other agents and chemicals on the test strips. This assay device has a simplified but reliable structure which integrates the assay or test elements within the container in which the liquid sample to be tested is collected. This assay device does not require any pipetting of the liquid sample or specimen, adding or mixing of reagents or other manipulation of the device by the user. This device is particularly suitable for the immediate, point of collection screening for drugs of abuse and offers health care, law enforcement, government, industrial safety and educational professionals a self-contained, one-step screening device capable of identifying illicit drug use within minutes.

It will be understood that this invention is susceptible to modification in order to adapt it to different usages and conditions, and accordingly, it is desired to comprehend such modifications within this invention as may fall within the scope of the appended claims.

What is claimed is:

1. An assay device for testing of a liquid sample for drugs of abuse comprising
a transparent container having an open top and a bottom for retaining a liquid sample to be tested,
an assay test strip holder within said container and having a front surface and a bottom end portion
means for positioning said strip holder in said container such that its front surface is closely adjacent to a wall of the container,
said strip holder having means thereon for defining one or more parallel elongated vertically extending pockets each having an open bottom,
an assay test strip disposed in a said pocket such that the sample receiving end of each test strip protrudes outwardly of a said pocket to contact a liquid sample,
each said test strip being visible through said pocket and said container,
and means for locking said strip holder in a position within said container.

2. An assay device as claimed in claim 1 wherein said strip holder front surface conforms to the configuration of the container wall and is positioned against the container wall.

3. An assay device as claimed in claim 1 wherein said container is cylindrical in shape.

4. An assay device as claimed in claim 3 wherein a portion of the cylindrical wall is flat.

5. An assay device as claimed in claim 4 wherein said strip holder front surface is flat so as to be positioned against the flat wall portion.

6. An assay device as claimed in claim 4 wherein said cylindrical container wall has two flat wall portions opposed from each other,
and means for positioning and locking a strip holder against each of said flat wall portions.

7. An assay device as claimed in claim 1 wherein said positioning means comprises co-acting means on said strip holder and the inner wall of said container,
and said locking means comprises co-acting means on said strip-holder and said container bottom.

8. An assay device as claimed in claim 1 wherein said positioning means comprises a flange at the top end of said strip holder and having an opening therein,
there being a projecting tab on the inner wall of said container and insertable into said flange opening to position said strip holder.

9. An assay device as claimed in claim 1 wherein said locking means comprises one or more hooks upwardly extending from the bottom of the container,
there being one or more corresponding notches on the rear side of said strip holder and engageable with said hooks to lock said strip holder in position within said container.

10. An assay device as claimed in claim 1 wherein the open bottoms of said pockets are spaced upwardly above the bottom end portion of said strip holder.

11. An assay device as claimed in claim 1 wherein said strip holder has a rectangular shape and front and rear surfaces,
said rectangular strip holder having a longer dimension disposed vertically within said container,
said front surface comprising a thin sheet member having one side thereof positioned against the container inner wall and another side defining a surface of said pockets such that a test strip within said pocket is closely adjacent to said one side of said front surface member.

12. An assay device as claimed in claim 1 wherein said strip holder is made from a clear plastic material and is rigid.

13. An assay device as claimed in claim 12 wherein said strip holder is made by injection molding.

14. An assay device as claimed in claim 1 wherein said pockets taper inwardly toward the top of the strip holder to secure a test strip therein.

15. An assay device as claimed in claim 1 wherein said test strips are immunoassay lateral flow test strips.

16. A process for testing of a liquid sample for drugs of abuse comprising the steps of
retaining a liquid sample in a transparent container having an open top and a bottom and further having a transparent test strip holder therein having one or more parallel elongated vertically extending pockets each having an open bottom end,
the strip holder being locked in a vertical position onto the bottom of the container such that the pockets are closely adjacent to the container wall,
there being one or more immunoassay test strips each respectively in a pocket visible through the container wall and the bottom sample receiving end of each test strip protruding from the pocket open bottom end,
contacting the liquid sample in the container with the protruding sample receiving end of the test strip to enable the liquid sample to wick up the test strip by capillary action to react with the test strip,
and reading the test results on each test strip through the wall of the transparent container.

17. A process as claimed in claim 16 wherein the container is cylindrical and has a flattened wall portion against which the strip holder is locked in position.
